(19) United States
(12) Patent Application Publication
(10) Pub. No.: US 2013/0226936 A1
(43) Pub. Date: Aug. 29, 2013

(54) ELECTRONIC DEVICE AND METHOD FOR SEARCHING RELATED TERMS

(71) Applicants: CHUNG-I LEE, Tu-Cheng (TW); CHIEN-FA YEH, Tu-Cheng (TW); GEN-CHI LU, Tu-Cheng (TW)

(72) Inventors: CHUNG-I LEE, Tu-Cheng (TW); CHIEN-FA YEH, Tu-Cheng (TW); GEN-CHI LU, Tu-Cheng (TW)

(73) Assignee: HON HAI PRECISION INDUSTRY CO., LTD., Tu-Cheng (TW)

(21) Appl. No.: 13/602,311

(22) Filed: Sep. 3, 2012

(30) Foreign Application Priority Data
Feb. 24, 2012 (CN) 201210044065.7

(51) Int. Cl. G06F 17/30

(52) U.S. Cl. 707/748; 707/E17.071

(57) ABSTRACT

In a method for searching for related terms, one or more query terms are received from a client computer. The method determines hyponym terms of each query term, merges all the hyponym terms of the query terms into a set of the hyponym terms, and calculates a weight factor of each hyponym term in the set of the hyponym terms. The method further determines a specified number of hyponym terms according to the weight factor of each hyponym term, adds the determined hyponym terms into related terms of the query terms, and performs a search operation based on the hyponym terms of the query terms, the related terms of the query terms, and the query terms.

### BACKGROUND

1. Technical Field

Embodiments of the present disclosure relate to file search technology, and particularly to an electronic device and method for searching for related terms using the electronic device.

2. Description of Related Art

Related terms of preset query terms can be obtained using a natural language processing (NLP) method by calculating a relevance score between every two of the query terms. Generally, two methods are used to calculate the relevance score between every two query terms. In a first method, the relevance score between every two of the query terms is calculated according to an angle between two vectors of every two terms. The smaller the angle between the two vectors, the larger the relevance score of the two terms is.

In a second method, the relevance score between every two of the query terms is obtained by calculating a conditional probability between every two of the query terms. The larger the conditional probability between two terms, the larger the relevance score according to this method. Therefore, a new method for searching related terms is desired.

### BRIEF DESCRIPTION OF THE DRAWINGS

FIG. 1 is a block diagram of one embodiment of an electronic device including a related term search system.

FIG. 2 is a schematic diagram of function modules of one embodiment of the related term search system included in the electronic device of FIG. 1.

FIG. 3 is a flowchart of one embodiment of a method for searching for related terms using the electronic device of the FIG. 1.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other storage medium.

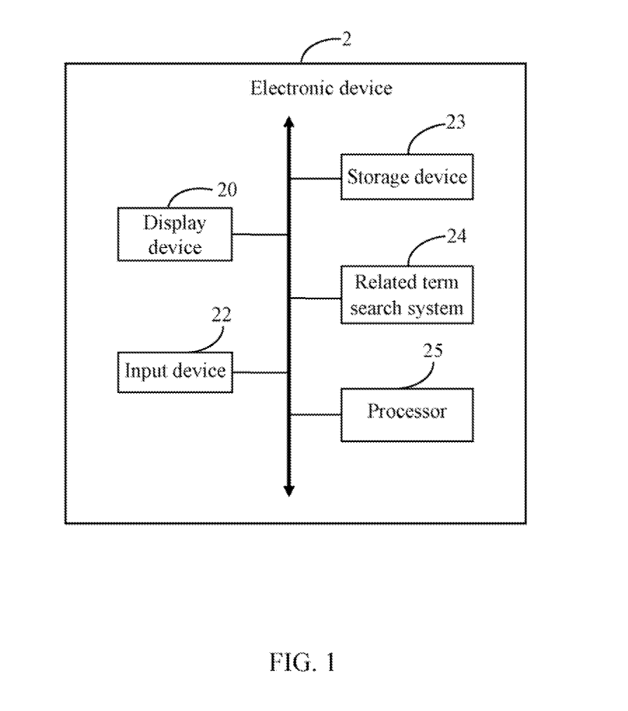

FIG. 1 is a block diagram of one embodiment of an electronic device 2 including a related term search system 24. In the embodiment, the electronic device 2 further includes a display device 20, an input device 22, a storage device 23, and at least one processor 25. The electronic device 2 may be a computer, a smart phone or a personal digital assistant (PDA). It should be understood that FIG. 1 illustrates only one example of the electronic device 2 that may include more or fewer components than illustrated, or have a different configuration of the various components in other embodiments.

The display device 20 may be used to display search results matching with preset query terms, and the input device 22 may be a mouse or a keyboard used to input computer readable data. The storage device 23 may be a non-volatile computer storage chip that can be electrically erased and reprogrammed, such as a hard disk or a flash memory card.

The related term search system 24 is used to determine hyponym terms of query terms input by a user, and obtain related terms of the query terms according to the determined hyponym terms. In one embodiment, a hyponym term is a word or phrase whose semantic field is included within that of another word, for example, oak is a hyponym of tree, and dog is a hyponym of animal. The related terms have direct or indirect relationships with the query terms, for example, handheld phone is a related term of mobile phone. In one embodiment, the related term search system 24 may include computerized instructions in the form of one or more programs that are executed by the at least one processor 25 and stored in the storage device 23 (or memory). A detailed description of the related term search system 24 will be given in the following paragraphs.

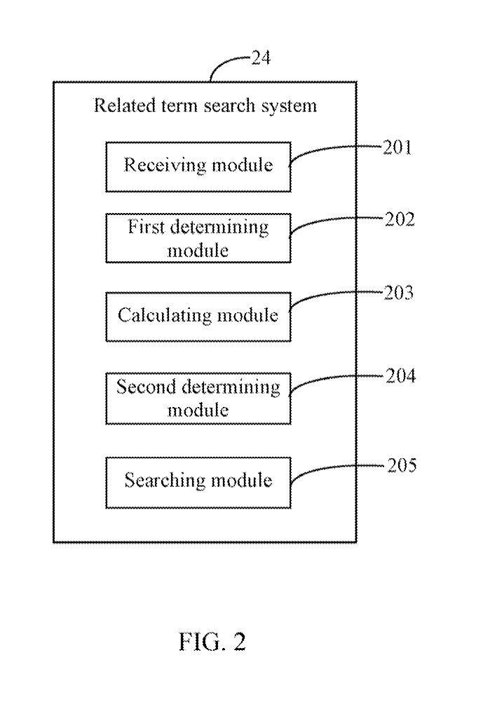

FIG. 2 is a block diagram of function modules of the related term search system 24 included in the electronic device 2. In one embodiment, the related term search system 24 may include one or more modules, for example, a receiving module 201, a first determining module 202, a calculating module 203, a second determining module 204, and a searching module 205. In general, the word “module”, as used herein, refers to logic embodied in hardware or firmware, or to a collection of software instructions, written in a programming language. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include flash memory and hard disk drives.

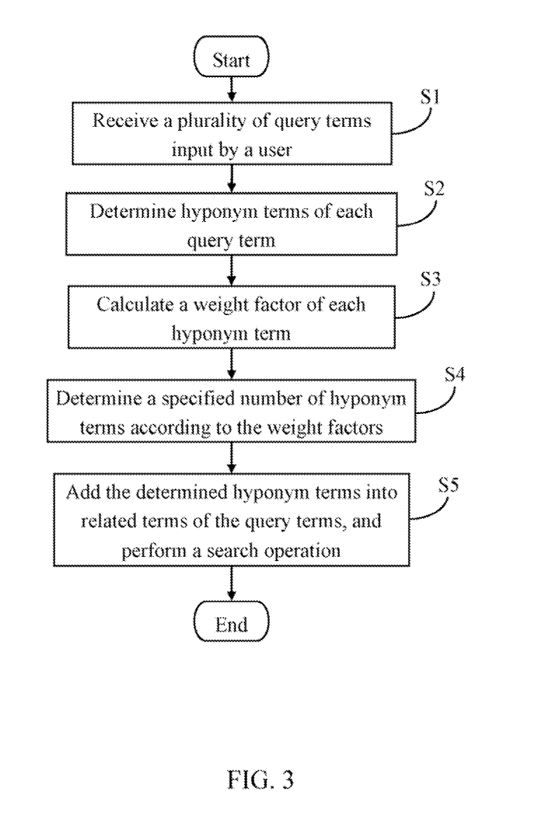

FIG. 3 is a flowchart of one embodiment of a method for searching for related terms using the electronic device 2. Depending on the embodiment, additional steps may be added, others removed, and the ordering of the steps may be changed.

In step S1, the receiving module 201 receives a plurality of query terms input by the user from a client computer, for example, the receiving module 201 receives input via a mouse, a touch screen, or a keyboard, etc. In one embodiment, one or more unimportant words (e.g., stop words) are removed from the query terms. That is, the query terms merely includes core terms which are important to search operations. In one embodiment, the unimportant words at least include articles, adverbs, and quantifiers, such as “a”, and “the” and “this”.

In step S2, the first determining module 202 determines hyponym terms of each of the query terms from the storage device 23. In one embodiment, the hyponym terms of each of the query terms may be pre-established (or pre-determined) manually and stored in the storage device 23, and the first determining module 202 may obtain the hyponym terms corresponding to each query term from the storage device 23.

In step S3, the calculating module 203 merges all the hyponym terms of the query terms into a set of the hyponym terms, and calculates a weight factor of each hyponym term in the set of the hyponym terms. In one embodiment, a number of occurrence times (hereinafter refer to as “occurrence number”) of a hyponym term repeated in the set of the hyponym terms is determined to be a weight factor of the hyponym term.

For example, suppose that the user inputs four query terms, “Hyponym1” represents a first hyponym set of a first query term, Hyponym1=(h1, h2, h5), “Hyponym2” represents a second hyponym set of a second query term, Hyponym2=(h2, h4, h5, h7), “Hyponym3” represents a third hyponym set of a third query term, Hyponym3=(h1, h6), and “Hyponym4” represents a fourth hyponym set of a fourth query term, Hyponym4=(h1, h7, h8). Then, the occurrence number of each hyponym term in the set of the four hyponym sets is as follows: Hyponym=(h1:3, h2:2, h4:1, h5:2, h6:1, h7:2, h8:1). That is, the weight factor of each hyponym term is as follows: h1=3, h2-2, h4-1, h5-2, h6-1, h7-2, h8-1.

In step S4, the second determining module 204 determines a specified number of the hyponym terms in the set of the hyponym terms according to the weight factors of the hyponym terms. For example, the second determining module 204 arranges the hyponym terms according to a descending sequence of the weight factor, and selects the specified number of hyponym terms according to descending sequence. In other embodiments, the second determining module 204 may arrange the hyponym terms according to other specified sequence (e.g., an ascending sequence) of the weight factor, and select the specified number of hyponym terms according to an ascending sequence.

For example, an rearranged set of the above-mentioned hyponym terms is as follows: Hyponym=(h1:3, h2:2, h5:2, h7:2, h4:1, h6:1, h8:1). If the specified number is three, the hyponym terms of “h1, h2, and h5” are selected by the second determining module 204.

Because the hyponym terms which have the lower weight factor are filtered by the second determining module 204, the search results based on the hyponym terms of the query terms are more accurate. For example, if the user inputs two query terms, such as “slide” and “mobile phone”, the present disclosure can determine an accurate hyponym term of “slide mobile phone”, and further determine related terms as being “slide smart phone”, “slide handheld phone”, and so on. The hyponym term of “slide battery panel” may be filtered by the present disclosure if the hyponym term of “slide battery panel” has a lower weight factor. Then, an accurate search operation may be performed based on the accurate hyponym term, the related terms, and the query terms.

In step S5, the searching module 205 adds the determined hyponym terms into related terms of the query terms, obtains search results from a data source by performing a search operation from a data source (e.g., USPTO) based on the hyponym terms of the query terms, the related terms of the query terms, and the query terms, and displays the search results on the display device 20.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for searching related terms using an electronic device, the method comprising:
receiving a plurality of query terms from a client computer;
determining hyponym terms of each of the query terms;
merging all the hyponym terms of the query terms into a set of the hyponym terms, and calculating a weight factor of each of the hyponym terms in the set of the hyponym terms;
determining a specified number of hyponym terms according to the weight factor of each of the hyponym terms; and
adding the determined hyponym terms into related terms of the query terms, and performing a search operation based on the hyponym terms of the query terms, the related terms of the query terms, and the query terms.

2. The method according to claim 1, wherein an occurrence number of the hyponym term in the set of the hyponym terms is determined to be the weight factor of the hyponym term.

3. The method according to claim 1, wherein the specified number of hyponym terms is determined by:
arranging the hyponym terms according to a specified sequence of the weight factor, and selecting the specified number of the hyponym terms according to specified sequence.

4. The method according to claim 3, wherein the specified sequence is a descending sequence of the weight factor.

5. The method according to claim 3, wherein the specified sequence is an ascending sequence of the weight factor.

6. An electronic device, comprising:
a storage device;
at least one processor; and
one or more modules that are stored in the storage device and are executed by the at least one processor, the one or more modules comprising:
a receiving module that receives a plurality of query terms from a client computer;
a first determining module that determines hyponym terms of each of the query terms;
a calculating module that merges all the hyponym terms of the query terms into a set of the hyponym terms, and calculates a weight factor of each of the hyponym terms in the set of the hyponym terms;
a second determining module that determines a specified number of hyponym terms according to the weight factor of each of the hyponym terms; and
a searching module that adds the determined hyponym terms into related terms of the query terms, and performs a search operation based on the hyponym terms of the query terms, the related terms of the query terms, and the query terms.

7. The electronic device according to claim 6, wherein an occurrence number of the hyponym term in the set of the hyponym terms is determined to be the weight factor of the hyponym term.

8. The electronic device according to claim 6, wherein the second determining module determines a specified number of hyponym terms by:
arranging the hyponym terms according to a specified sequence of the weight factor, and selecting the specified number of the hyponym terms according to specified sequence.

9. The electronic device according to claim 8, wherein the specified sequence is a descending sequence of the weight factor.

10. The electronic device according to claim 8, wherein the specified sequence is an ascending sequence of the weight factor.

11. A non-transitory storage medium having stored thereon instructions that, when executed by a processor of an electronic device, causes the electronic device to perform a method for searching related terms, the method comprising:
receiving a plurality of query terms from a client computer;
determining hyponym terms of each of the query terms;
merging all the hyponym terms of the query terms into a set of the hyponym terms, and calculating a weight factor of each of the hyponym terms in the set of the hyponym terms;
determining a specified number of hyponym terms according to the weight factor of each of the hyponym terms; and
adding the determined hyponym terms into related terms of the query terms, and performing a search operation based on the hyponym terms of the query terms, the related terms of the query terms, and the query terms.

12. The non-transitory storage medium according to claim 11, wherein an occurrence number of the hyponym term in the set of the hyponym terms is determined to be the weight factor of the hyponym term.

13. The non-transitory storage medium according to claim 11, wherein the specified number of hyponym terms is determined by:
arranging the hyponym terms according to a specified sequence of the weight factor, and selecting the specified number of the hyponym terms according to specified sequence.

14. The non-transitory storage medium according to claim 13, wherein the specified sequence is a descending sequence of the weight factor.

15. The non-transitory storage medium according to claim 13, wherein the specified sequence is an ascending sequence of the weight factor.

16. The non-transitory storage medium according to claim 11, wherein the medium is selected from the group consisting of a hard disk drive, a compact disc, a digital video disc, and a tape drive.
